(19) United States
(12) Patent Application Publication
(10) Pub. No.: US 2024/0375653 A1
(43) Pub. Date: Nov. 14, 2024

(54) Control Device and Method for Controlling a Predictive Cruise Control

(71) Applicant: Scania CV AB, Södertälje (SE)

(72) Inventor: Tomas Selling, Tyresö (SE)

(21) Appl. No.: 18/655,654

(22) Filed: May 6, 2024

(30) Foreign Application Priority Data
May 8, 2023 (SE) 2350560-5

(51) Int. Cl. B60W 30/14; B60W 50/00; B60W 50/14

(52) U.S. Cl. CPC B60W 30/143; B60W 50/0097; B60W 50/14; B60W 2050/146; B60W 2420/403; B60W 2420/408; B60W 2520/10; B60W 2540/215; B60W 2554/402; B60W 2554/4042; B60W 2554/406; B60W 2554/80; B60W 2556/45

(57) ABSTRACT

A control device and a method for controlling a predictive cruise control of a vehicle. The method comprises, based on an assessment of a traffic situation behind the vehicle and a current set speed, determining a minimum allowable vehicle (v_a). The method further comprises, in response to a determination that the determined minimum allowable speed (v_a) is lower than a currently selected minimum speed threshold (v_min) and a predetermined condition is fulfilled, adjusting the currently selected minimum speed threshold (v_min) to correspond to the determined allowable vehicle speed (v_a). A predictive cruise control and a vehicle, comprising the control device, are also provided, as well as a computer program and a computer-readable medium.

### TECHNICAL FIELD

The present disclosure relates in general to a method for controlling a predictive cruise control of a vehicle. The present disclosure also relates in general to a control device configured to control a predictive cruise control of a vehicle. Furthermore, the present disclosure relates in general to a computer program, a computer-readable medium and to a vehicle.

### BACKGROUND

Cruise controls that automatically controls the travelling speed of a vehicle are common in modern vehicles today. When activated, a cruise control eliminates the need of a driver to operate an accelerator pedal in order to maintain the vehicle speed and thereby improves driver comfort. A cruise control may also reduce the energy consumption of the vehicle during operation, and can therefore lead to reduced operating costs. There are various types of cruise controls, which are configured to operate according to different control functions and therefore may result in different effects on for example the operation of the vehicle.

One example thereof is a traditional cruise control that aims at maintaining a substantially constant vehicle speed, such as a set speed selected by a driver of the vehicle. Such a traditional cruise control may often be referred to as a constant speed cruise control. A constant speed cruise control is typically configured to maintain the vehicle speed within a narrow allowable speed range about the set speed and with the aim to maintain the vehicle speed at the set speed. The allowable speed range is defined by a maximum allowable vehicle speed and a minimum allowable vehicle speed, which are generally dependent of the set speed. For example, in case the set speed is 70 km/h, the allowable speed range may typically be from 68 km/h to 72 km/h.

A constant speed cruise control thus controls the vehicle with the aim to maintain the set speed set regardless of whether the vehicle is travelling uphill, downhill or on a horizontal running surface. This means that the vehicle may be accelerated over the crest of a hill, only to be immediately braked on a subsequent downgrade to avoid exceeding the set speed. This is an uneconomic way of running the vehicle, particularly in the case of heavy vehicles, since it may often unduly increase the energy consumption of the vehicle and hence the operating costs (such as fuel costs).

Another type of cruise control is a predictive cruise control, sometimes also referred to as a look-ahead cruise control. A predictive cruise control is a cruise control which uses information regarding an upcoming road section, i.e. a road section ahead of the vehicle, and plans a vehicle speed profile for the upcoming road section based on said information. The information regarding the upcoming road section may typically include at least topographic data and data relating to the curvature or the like of the upcoming road section, but could also include information relating to for example traffic situation ahead of the vehicle and/or speed limits. The data may typically be derived from map data in combination with information regarding geographical positioning of the vehicle, but may in some situations also be supplemented with for example historical data relating to previous instances that the vehicle, or another vehicle, has travelled the upcoming road section. The predictive cruise control then controls the vehicle speed in accordance with the planned vehicle speed profile as the vehicle travels the road section in question.

Predictive cruise controllers can save substantial amounts of fuel compared to constant speed cruise controllers. For example, in case the upcoming road section comprises an uphill followed by a downhill, the vehicle may be accelerated so as to, at the crest of the hill, having a speed which is lower than the set speed if the vehicle speed will increase during the downhill as a result of the gravitational force so as to reach the set speed. In order to take advantage of the positive effect obtainable by a predictive cruise control, the allowable speed range of the vehicle for such a cruise control is typically considerably broader than the allowable speed range of a constant speed cruise control. However, in some situations, a predictive cruise control may risk leading to a disruption of traffic flow or otherwise negatively affect the traffic situation. For example, other road users may be surprised and/or disturbed in case of a considerable reduction in travelling speed of the vehicle whose speed is controlled by a predictive cruise control. This may in turn lead to rapid braking by other road users and/or dangerous overtaking of the vehicle by other road users. For said reasons, the allowable reduction in vehicle speed permitted by a predictive cruise control is generally calibrated to not cause any substantial disturbance to other road users.

Both a constant speed cruise control and a predictive cruise control may sometimes also be supplemented by an adaptive cruise control function, if desired. The adaptive cruise control function is configured to automatically adjust the vehicle speed in order to maintain a safe distance to other road users ahead of the vehicle. An adaptive cruise control function typically uses information from sensors arranged in or on the vehicle, such as radar, laser or image capturing devices (such as cameras), for the purpose of obtaining information regarding such other road users in front of the vehicle.

### SUMMARY

The object of the present invention is to enable further energy savings and thereby improve operating costs for a vehicle whose speed is controlled by a cruise controller.

The object is achieved by the subject-matter of the appended independent claim(s).

The present disclosure provides a method, performed by a control device, for controlling a predictive cruise control of a vehicle. The predictive cruise control is configured to control vehicle speed in accordance with a planned vehicle speed for an upcoming road section, wherein said planned vehicle speed is determined based on a set speed, a minimum speed threshold and characteristics of the upcoming road section. The method comprises a step of, based on an assessment of a traffic situation behind the vehicle and a current set speed, determining a minimum allowable vehicle speed. The method further comprises a step of, in response to a determination that the determined minimum allowable speed is lower than a currently selected minimum speed threshold and a predetermined condition is fulfilled, adjusting the currently selected minimum speed threshold to correspond to the determined minimum allowable vehicle speed.

By means of the herein described method, the minimum speed threshold of the predictive cruise control may be reduced in situations where other road users may not be disturbed by a possible unexpected reduction of the vehicle speed of the vehicle. The reduction of the minimum speed threshold results in an increased vehicle speed interval within which the predictive cruise control is allowed to vary the vehicle speed. This may in turn enable the predictive cruise control to utilize a vehicle speed profile for the upcoming road section which represents a more energy efficient driving strategy. Thereby, further energy savings may be made and thereby a reduction of the operating cost of the vehicle without disturbing the traffic flow or reduce road safety.

The method may further comprise a step of assessing the traffic situation behind the vehicle, wherein said step comprises determining whether there is at least one other road user present behind the vehicle. Thereby, the accuracy in the determined minimum allowable vehicle speed may be improved.

The step of determining whether there is at least one other road user present behind the vehicle may be performed by analysis of data obtained from at least one sensor onboard the vehicle and/or information received via a communication system configured to allow the control device to receive information from a remote source. Thereby, the accuracy in the assessment of the traffic situation behind the vehicle may be improved, which in turn affects the accuracy in the determined minimum allowable speed.

The at least one sensor onboard the vehicle may be selected from the group consisting of a radar sensor, a lidar sensor, or an image capturing device.

The step of assessing the traffic situation may further comprise identifying the type of said at least one other road user present behind the vehicle and/or estimating the travelling speed of said at least one other road user present behind the vehicle. This further improves the assessment of the traffic situation behind the vehicle and therefore also the accuracy in the determination of the minimum allowable speed.

The above mentioned predetermined condition may include that adjustment of the minimum speed threshold is permitted for a currently operative performance mode of the vehicle. Thereby, it is ensured that the currently selected minimum speed threshold is not adjusted to a lower value in situations where it is expected that the driver would be disturbed by possibly greater differences in vehicle speed.

The method may further comprise a step of, in response to the determination that the determined minimum allowable speed is lower than the currently selected minimum speed threshold, proposing an adjustment of the minimum speed threshold to a driver of the vehicle and enabling the driver, by use of a user interface, to request said adjustment. In such a case, the predetermined condition may include that a driver-initiated request for adjustment of the minimum speed threshold has been generated. Thereby, it is avoided that the minimum speed threshold is reduced in situations where the driver would find such a reduction to be disturbing or otherwise unwanted, for example for possibly increasing the travel time to intended destination.

The predetermined condition may alternatively, or additionally, include that the characteristics of the upcoming road section are determined to allow for safe overtaking of the vehicle by other road users. Thereby, it is ensured that the currently selected minimum speed threshold is not adjusted to a lower value which could result in such low vehicle speeds of the vehicle that it may jeopardize road safety.

Determining whether the characteristics of the upcoming road section allow for safe overtaking of the vehicle by other road users may be based on number of lanes with the same direction of travel of the vehicle. Thereby, road safety is further improved.

The step of determining a minimum allowable vehicle speed may according to a first alternative comprise selecting the minimum allowable speed from a look-up table comprising predefined values for minimum allowable speeds for different set speeds and assessments of traffic situation behind the vehicle. Thereby, a reliable determination of minimum allowable vehicle speed may easily be made.

Alternatively, the step of determining a minimum allowable vehicle speed may according to a second alternative comprise estimating a possible lowest vehicle speed of the vehicle enabling said at least one other road user to reach a minimum allowable trailing distance to the vehicle. Thereby, there is no need for access to a look-up table comprising predefined values for minimum allowable speeds for different set speeds and assessments of traffic situation behind the vehicle.

The present method may further comprise a step of, in response to a determination that the determined minimum allowable speed is higher than a currently selected minimum speed threshold, optionally by at least a predefined difference threshold value, adjusting the currently selected minimum speed threshold to correspond to the determined minimum allowable vehicle speed or a predefined default minimum speed threshold. Thereby, the risk of causing disturbance to other road users is reduced and road safety is increased as a result of lower possible variations of vehicle speed of the vehicle.

The present disclosure further relates to a computer program comprising instructions which, when executed by a control device, cause the control device to carry out the method as described above.

The present disclosure further relates to a computer-readable medium comprising instructions which, when executed by a control device, cause the control device to carry out the method as described above.

Moreover, the present disclosure further provides a control device configured to control a predictive cruise control of a vehicle Said predictive cruise control configured to control vehicle speed in accordance with a planned vehicle speed profile for an upcoming road section, wherein said planned vehicle speed profile is determined based on a set speed, a minimum speed threshold and characteristics of the upcoming road section. The control device is configured to, based on an assessment of a traffic situation behind the vehicle and a current set speed, determine a minimum allowable vehicle speed. The control device is further configured to, when the determined minimum allowable speed is lower than a currently selected minimum speed threshold and a predetermined condition is fulfilled, adjust the currently selected minimum speed threshold to correspond to the determined minimum allowable vehicle speed.

The control device provides the same advantages as described above with reference to the corresponding method for controlling a predictive cruise control of a vehicle.

The present disclosure further provides a predictive cruise control for a vehicle, said predictive cruise control comprising the above described control device.

Moreover, the present disclosure further provides a vehicle comprising the control device described above. The vehicle may be a land-based heavy vehicle, such as a bus or a truck. Moreover, the vehicle may be a fully electrical vehicle, a combustion engine powered vehicle or a hybrid vehicle. The vehicle may be a vehicle configured to a driven fully or in part by a driver. Alternatively, the vehicle may be a fully autonomous vehicle.

### BRIEF DESCRIPTION OF DRAWINGS

FIG. 1 schematically illustrates an example of a vehicle,

FIG. 2 schematically illustrates a plurality of vehicle speed profiles for an upcoming road section,

FIG. 3 represents a flowchart schematically illustrating one exemplifying embodiment of the method for controlling a predictive cruise control of a vehicle, and

FIG. 4 schematically illustrates an exemplifying embodiment of a device which may comprise, consist of, or be comprised in a control device configured to control a predictive cruise control of a vehicle.

### DETAILED DESCRIPTION

The invention will be described in more detail below with reference to exemplifying embodiments and the accompanying drawings. The present invention is however not limited to the exemplifying embodiments discussed and/or shown in the drawings, but may be varied within the scope of the appended claims. Furthermore, the drawings shall not be considered drawn to scale as some features may be exaggerated in order to more clearly illustrate the invention or features thereof.

In the present disclosure, the term “driver” shall be considered to encompass both a driver present in a vehicle as well as a driver controlling the vehicle but not being present in the vehicle, such as a driver controlling the vehicle from a remote control center or the like.

Moreover, the term “upcoming road section” is herein used to describe a section of the road in front of a vehicle, and which said vehicle is about to travel on. The upcoming road section may suitably be a road section essentially immediately in front of the vehicle, but the present disclosure is not limited thereto. The upcoming road section may for example start a few meters in front of the vehicle.

In the present disclosure, a predictive cruise control is considered to mean a cruise control which is configured to use information regarding road characteristics ahead of the vehicle and, based on said information, plan a driving strategy for the upcoming road section and thereafter control the vehicle speed in accordance with said driving strategy. The driving strategy is determined in consideration of a set speed, which may typically be selected by a driver of the vehicle and represents the vehicle speed the driver wishes the vehicle to essentially maintain. Alternatively, the set speed may be selected by a control system of the vehicle e.g. in consideration of legal requirements relating to the upcoming road section (such as speed limit) and in consideration of a speed selected by the driver. Typically, a predictive cruise control is configured to at least consider topography and curvature of the upcoming road section. Such information may for example be derived from map data when used in combination with geographical positioning of the vehicle. In other words, a predictive cruise control is configured to vary the vehicle speed in accordance with a predetermined (i.e. planned) vehicle speed profile for an upcoming road section, said predetermined vehicle speed profile being based on characteristics of the upcoming road section. A predictive cruise control is sometimes referred to as a look-ahead cruise control in the art.

A predictive cruise control may be configured to determine a driving strategy for the upcoming road section based on simulation of a plurality of vehicle speed profiles for various driving conditions for the upcoming road section, and selecting the simulated vehicle speed profile which appears to be the most appropriate from the plurality of simulated vehicle speed profiles as the planned vehicle speed profile to be used for the control of vehicle speed. Typically, the most energy efficient vehicle speed profile, which fulfills a current set of control values (as will be described further below), is selected as the planned vehicle speed profile. However, other factors, such as driver comfort and/or time to reach a destination, may additionally or alternatively be considered when selecting the planned vehicle speed profile. A simulated vehicle speed profile defines simulated vehicle speed at different distance points along the upcoming road section and at least comprises the extreme points, i.e. the simulated maximum vehicle speed together with its associated distance point as well as the simulated minimum vehicle speed with its associated distance point. The simulated vehicle speed profile may comprise or consist of a plurality of simulated discrete values of vehicle speed at various distance points along the road section. Suitably, the simulated vehicle speed profile may be a simulated continuous vehicle speed profile. Simulation of a vehicle speed profile for an upcoming road section is nowadays well known to a person skilled in the art and will therefore not be described in detail here. Examples of factors that may typically be considered in such a simulation, in addition to geographical data relating to the upcoming road section (including topography, curvature of road etc.), include for example vehicle configuration, vehicle load etc. Advanced simulations of vehicle speed profiles for upcoming road sections may also take into consideration additional factors, such as weather conditions and/or road conditions.

Furthermore, a predictive cruise control may be configured to control the vehicle speed in consideration of a set of control values, said set of control values comprising (or consisting of) a set speed (cc_Set), a minimum speed threshold (v_min) and usually also a maximum speed threshold (v_max). The minimum speed threshold and maximum speed threshold together define an allowable vehicle speed interval within which the vehicle speed may be allowed to be varied in consideration of a currently selected set speed. As mentioned above, the predictive cruise control may be configured to determine a suitable vehicle speed profile for the upcoming road section by comparing a plurality of simulated vehicle speed profiles in terms of energy consumption of the vehicle. The simulated vehicle speed profile providing the lowest energy consumption of the vehicle, and which fulfils the plurality of control values described above, may thereafter be selected for the upcoming road section, and thus constitutes the planned vehicle speed profile. However, the minimum speed threshold (and, where applicable, also the maximum speed threshold) provides a restriction on the possible vehicle speed profiles for an upcoming road section that are available for the predictive cruise control to select. For example, if a possible vehicle speed profile would, at some point, result in a vehicle speed which is lower than the minimum speed threshold, said vehicle speed profile may not be utilized by the predictive cruise control when controlling the vehicle speed.

In a predictive cruise control, there may typically be, for each possible set speed of the predictive cruise control, a default minimum speed threshold and a default maximum speed threshold. The default maximum speed threshold may for example be selected so as to not cause any unexpected behavior of the vehicle to a driver and/or be based on vehicle configuration, vehicle load, safety considerations, and/or legal requirements etc. The default minimum speed threshold may for example be selected (i.e. calibrated) such that a possible reduction in vehicle speed to the default minimum speed threshold would not cause any substantial disturbance to other road users and/or would not be seen as unexpected or disturbing to a driver of the vehicle. This however means that the full potential of the predictive cruise control, in terms of energy savings in the operation of the vehicle, is not utilized. This problem is however addressed by the herein described method.

It should here be noted that the minimum allowable speed threshold and the maximum allowable speed threshold of a predictive cruise control may sometimes be adjusted from the above described default set of control values for a specific set speed. This means that the minimum allowable speed threshold and the maximum allowable speed threshold may be adjusted independently of each other, or independence of each other, without having to adjust a current set speed of the predictive cruise control. It should however be noted that the maximum allowable speed threshold is always equal to or higher than a current set speed of the predictive cruise control. Furthermore, the minimum allowable speed threshold is always lower than the current set speed of the predictive cruise control.

The present disclosure provides a method, performed by a control device configured therefore, for controlling a predictive cruise control of a vehicle. The method comprises a step of, based on an assessment of a traffic situation behind the vehicle and a current set speed, determining a minimum allowable vehicle speed. Said minimal allowable vehicle speed may be described as a lowest acceptable speed of the vehicle, as the vehicle travels the upcoming road section, in view of a current set speed and the traffic situation behind the vehicle whose speed is controlled by the predictive cruise control. The method further comprises a step of, in response to a determination that the determined minimum allowable speed is lower than a currently selected minimum speed threshold and a predetermined condition is fulfilled, adjusting the currently selected minimum speed threshold to correspond to the determined minimum allowable vehicle speed.

In its broadest form, the above mentioned predetermined condition constitutes that an adjustment of a currently selected minimum speed threshold is not prohibited or inhibited for some reason. In other words, the predetermined condition is fulfilled when an adjustment of a currently selected minimum speed threshold is permitted. The predetermined condition thus ensures that an adjustment of the currently selected minimum speed threshold of the predictive cruise control to a lower minimum speed threshold is not performed when it may be, or is expected to be, undesired by e.g. a driver of the vehicle. Thus, the step of, in response to a determination that the determined minimum allowable vehicle speed is lower that a currently selected minimum speed threshold and a predetermined condition is fulfilled, adjusting the currently selected minimum speed threshold to correspond to the determined minimum allowable vehicle speed may alternatively be described as: in response to a determination that the determined minimum allowable vehicle speed is lower than a currently selected minimum speed threshold, adjusting the currently selected minimum speed threshold to correspond to the determined minimum allowable vehicle speed, unless such an adjustment is prohibited or inhibited.

The above described adjustment of the currently selected minimum speed threshold to correspond to the determined minimum allowable vehicle speed (when being lower that the currently selected minimum speed threshold) directly affects the possible vehicle speed profiles that are available for the predictive cruise control to utilize for an upcoming road section. This in turn means that the predictive cruise control may choose a more energy efficient vehicle speed profile which was perhaps not available for selection before the adjustment of the currently selected minimum speed threshold. For illustration of the herein described method, it is possible to consider an example at which the predictive cruise control is currently utilizing a default minimum speed threshold, preselected to not cause any significant disturbance to other road users, and the assessment of the traffic situation behind the vehicle demonstrates that there are no other road users behind the vehicle. In such a case, a minimum allowable vehicle speed may, based on the fact that there are no other road users behind the vehicle, be determined to be for example 3 km/h lower than the default minimum speed threshold. Unless an adjustment of the default minimum speed threshold is currently prohibited, the currently selected minimum speed threshold may be reduced to correspond to determined minimum allowable vehicle speed, which in the example was 3 km/h lower. This may in turn enable the predictive cruise control to utilize a more energy efficient vehicle speed profile for the control of the vehicle speed, if such a vehicle speed profile exists among the plurality of simulated vehicle speed profiles.

It should be noted that the herein described method does not necessarily comprise a step of determining a planned vehicle speed profile for an upcoming road section and/or a step of controlling the vehicle speed of the vehicle in accordance with the planned vehicle speed profile. Instead, the herein described method is primarily directed towards controlling the predictive cruise control in terms of which minimum speed threshold should be used by the predictive cruise control under given circumstances. However, when the control device, configured to perform the herein described method, is incorporated in the predictive cruise control, the method may also comprise a step of determining a planned vehicle speed profile based on a current set of control values comprising a current set speed, the minimum speed threshold (and optionally a maximum speed threshold) and the characteristics of the upcoming road section. Moreover, the method may in such a case naturally also comprise a step of controlling the vehicle speed in accordance with the planned vehicle speed profile.

The herein described method may further comprise a step of assessing the traffic situation behind the vehicle. Such a step of assessing the traffic situation behind the vehicle comprises at least determining whether there is at least one other road user present behind the vehicle. Determining whether there is at least one other road user present behind the vehicle may advantageously be performed by analysis of data obtained from at least one sensor onboard the vehicle and/or information received via a communication system configured to allow the control device to receive information from a remote source. Examples of sensors onboard the vehicle which may be used for obtaining data to be analyzed for the assessment of traffic situation behind the vehicle include radar sensors, lidar sensors and/or image capturing devices. Such image capturing devices may for example include various types of cameras, such as digital rear view mirrors, reversing cameras, and/or any other form of camera configured to monitor the environment behind the vehicle. Examples of communication systems configured to allow the control device to receive information from a remote source include, but are not limited to, vehicle-to-vehicle (V2V) communication systems and vehicle-to-anything (V2X) communication systems. As an example, in case the vehicle is a leading vehicle in a vehicle train, the other vehicles of the vehicle train may be ignored in view of following the leading vehicle. In such a case, it is the traffic situation behind the last vehicle in the vehicle train which needs to be considered. For said purpose, the control device may be configured to receive said information from e.g. the last vehicle of the vehicle train via a V2V communication system.

The step of assessing the traffic situation behind the vehicle may further comprise identifying the type of said at least one other road user present behind the vehicle, for example identifying if said at least one other road user is a heavy commercial vehicle (such as a truck), a passenger car, a motorbike or even an emergency vehicle. Different type of road users may have different expectations on possible speed reductions of vehicles in front and/or react differently to unexpected speed reductions of a vehicle in front. Therefore, the type of road user(s) identified behind the vehicle may advantageously be included in the assessment, such that this may be taken into account when determining the minimum allowable vehicle speed. For example, a truck driver may have a better understanding of vehicle speed variations that may result from usage of a predictive cruise control compared to a motorcyclist or a driver of a passenger car. Thus, a lower minimum allowable vehicle speed may be used in case of a truck being the sole other road user present behind the vehicle compared to e.g. a plurality of passenger cars and/or motor bikes.

Additionally, or alternatively, the step of assessing the traffic situation behind the vehicle may comprise estimating the travelling speed of said at least one other road user present behind the vehicle. The travelling speed of one or more other road users present behind the vehicle may advantageously be used in the assessment of the traffic situations as a lower minimum allowable vehicle speed may be used in case of said other road user(s) travelling at essentially the same or lower travelling speed as the vehicle whose speed is controlled by the predictive cruise control compared to if such other road user(s) has a higher travelling speed.

In case the herein described method does not comprise the step of assessing the traffic situation behind the vehicle, the control device configured to perform the herein described method may further be configured to obtain information of the above described assessment of the traffic situation behind the vehicle (whose speed may be controlled by the predictive cruise control) from another controller of the vehicle or from a remote source, and determine the minimum allowable speed based on received assessment.

As already mentioned above, the herein described method comprises adjusting the currently selected minimum speed threshold to correspond to the determined minimum allowable vehicle speed when said determined minimum allowable vehicle speed is lower than the currently selected minimum speed threshold and a predetermined condition is fulfilled, wherein said predetermined condition is fulfilled when said adjustment is permitted. The predetermined condition may for example include that an adjustment of the minimum speed threshold is permitted, by the predictive cruise control and/or the control device, for a currently operative performance mode. A vehicle may be operated at a number of difference performance modes, such as economy mode, standard driving mode or power driving mode. Such performance modes are typically selected by a driver of the vehicle and are thus indicative of the driver's expectations on how the vehicle should be operated.

Thus, in case the vehicle is operated in e.g. power driving mode, the driver would likely not desire a reduction of minimum speed threshold as this could result in larger speed variations of the vehicle. Therefore, the ability for adjusting the minimum speed threshold to values lower than a default minimum speed threshold may be prohibited or inhibited for said performance mode. In contrast, when an economy mode is utilized, the driver is likely interested in the most energy efficient operation of the vehicle and said performance mode may therefore permit adjustment of the minimum speed threshold.

Alternatively, or additionally, the predetermined condition may include that a driver of the vehicle has agreed to a reduction of minimum speed threshold. In such a case, the method may further comprise a step of, in response to the determination that the determined minimum allowable speed is lower than the currently selected minimum speed threshold of the predictive cruise control, proposing an adjustment of the minimum speed threshold to a driver of the vehicle and enabling the driver, by use of a user interface, to request said adjustment. In such a case, the predetermined condition includes that a driver-initiated request for adjustment of the minimum speed threshold has been generated. In other words, the control device will only adjust the currently selected minimum speed threshold to correspond to the determined minimum allowable vehicle speed if the driver-initiated request has been generated (i.e. the driver has confirmed that he agrees to the proposed adjustment).

According to yet an alternative, which may also supplement the above specified alternatives, the predetermined condition may include that the characteristics of the upcoming road section are determined to allow for safe overtaking of the vehicle by other road users. Described differently, the predetermined condition may according to this alternatively only be considered fulfilled if the characteristics of the upcoming road section are determined to allow for safe overtaking of the vehicle by other road users. The method may thus also comprise a step of determining whether the characteristics of the upcoming road section allows for safe overtaking of the vehicle. This may for example be made based on number of lanes of the upcoming road section with the same direction of travel of the vehicle. For example, an adjustment of a currently selected minimum speed threshold to a lower value may be prohibited or inhibited in case the road comprises a single lane in the same direction of travel, but permitted in case of the upcoming road comprising two or more lanes in the same direction of travel. This because an overtaking of the vehicle, which necessitates traveling in a lane of opposite direction of travel, presents a considerably higher risk for accidents compared to if performed in a lane with the same direction of travel. The step of determining whether the characteristics of the upcoming road section allow for safe overtaking of the vehicle by other road users may also be based on further characteristics of the upcoming road, such as curvature of the road or the like.

The above described step of determining a minimum allowable speed may according to a first alternative comprise selecting the minimum allowable speed from a pre-determined look-up table, stored by the control device or retrievable by the control device, comprising predefined values for minimum allowable speeds for different set speeds and assessments of traffic situations behind the vehicle.

According to a second alternative, the step of determining a minimum allowable speed may comprise estimating a possible lowest vehicle speed of the vehicle enabling said at least one other road user to reach a predefined minimum trailing distance to the vehicle. A trailing distance is here intended to mean the distance between the other road user and the vehicle whose speed is controlled by the predictive cruise control. A trailing distance may also sometimes be referred to as a “following distance”. Said possible lowest vehicle speed may then, possibly plus a predetermined offset, be determined to constitute the minimum allowable speed. For the purpose of performing such an estimation, the travelling speed of the other road user as well as the speed of the vehicle whose speed is controlled by the predictive cruise control need to be considered. This may be performed essentially in accordance with previously known methods for an adaptive cruise control function, with the exception that the other road user is present behind the vehicle whose speed is controlled by the cruise control. The second alternative for determining the minimum allowable speed has the advantage, compared to the first alternative, of not relying on previously determined data, but may increase the computational efforts and may sometimes be less accurate for being based on estimation of speeds.

The herein described method for controlling a predictive cruise control of a vehicle may further comprise a step of, in response to a determination that the determined minimum allowable speed is higher than a currently selected minimum speed threshold, optionally be at least a predefined difference threshold, adjusting the currently selected minimum speed threshold to correspond to the determined minimum allowable vehicle speed. In practice, this means that in situations where it is determined, based on the assessment of the traffic situation behind the vehicle, that the currently selected minimum speed threshold of the predictive cruise control is lower than appropriate (for example for risking a reduction of vehicle speed that may cause disturbance to other road users or even unsafe overtaking of the vehicle), the minimum speed threshold may be adjusted to correspond to the determined minimum allowable speed. This may possibly lead to an increase in energy consumption of the vehicle compared to if the currently selected minimum speed threshold is maintained. However, it increases the road safety. Furthermore, this reduces the risk of a driver being inclined to deactivate the predictive cruise control, which in turn could lead to a higher energy consumption of the vehicle as the advantages of the predictive cruise control would not be utilized.

As an alternative, the currently selected minimum speed threshold may be adjusted to correspond to a predefined default minimum speed threshold in response to the determination that the determined minimum allowable speed is higher than a currently selected minimum speed threshold, optionally by at least a predefined difference threshold value.

The predefined difference threshold value mentioned above may be selected to ensure that adjustment of the minimum speed threshold is not performed too often, and could for example be selected to be 1-3 km/h. The predefined difference threshold value may also vary for example with the set speed.

The performance of the herein described method for controlling a predictive cruise control of a vehicle may be governed by programmed instructions. These programmed instructions typically take the form of a computer program which, when executed in or by a control device, cause the control device to effect desired forms of control action. Such instructions may typically be stored on a computer-readable medium.

The present disclosure further relates to a control device configured to control a predictive cruise control of a vehicle. The control device may be configured to perform any one of the steps of the method for controlling a predictive cruise control of a vehicle as described herein.

More specifically, in accordance with the present disclosure, a control device configured to control a predictive cruise control of a vehicle is provided. Said predictive cruise control is configured to control vehicle speed in accordance with a planned vehicle speed profile for an upcoming road section, wherein said planned vehicle speed profile is determined based on a set speed, a minimum speed threshold and characteristics of the upcoming road section. The control device is configured to, based on an assessment of a traffic situation behind the vehicle and a current set speed, determine a minimum allowable vehicle speed. The control device is further configured to, when the determined minimum allowable speed is lower than a currently selected minimum speed threshold and a predetermined condition is fulfilled, adjust the currently selected minimum speed threshold to correspond to the determined minimum allowable vehicle speed.

The control device may further be configured to assess the traffic situation behind the vehicle, or to receive such an assessment from another controller. For example, the control device may be configured to receive such an assessment from a controller, remote from the vehicle, via a vehicle-to vehicle (V2V) communication system or a vehicle-to-anything (V2X) communication system.

Moreover, the control device may also be configured to, when the determined minimum allowable speed is higher than the currently selected minimum speed threshold, optionally by at least a predefined difference threshold value, adjust the currently selected minimum speed threshold to correspond to the determined minimum allowable vehicle speed. Alternatively, the control device may be configured to, when the determined minimum allowable speed is higher than the currently selected minimum speed threshold, optionally by at least a predefined difference threshold value, adjust the currently selected minimum speed threshold to correspond to a predefined default minimum speed threshold.

The control device may comprise one or more control units. In case of the control device comprising a plurality of control units, each control unit may be configured to control a certain function or a certain function may be divided between more than one control units. The control device may be a control device of predictive cruise control of the vehicle. Alternatively, the control device may be separate from the predictive cruise control, but configured to communicate with the predictive cruise control for the purpose of control thereof. The control device may also be a part of any other controller of the vehicle. The control device may be arranged in the vehicle. It is however also plausible that one or more control units of the control device may be arranged at a remote control center or the like, and configured to communicate with one or more control units of the control device arranged onboard the vehicle.

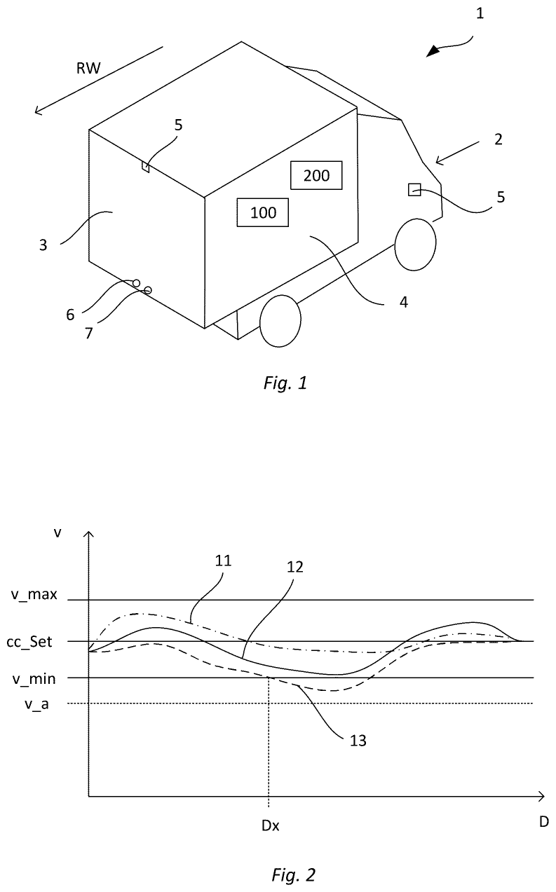

FIG. 1 schematically illustrates a perspective view of an example of a vehicle 1. The vehicle I may be a land-based motor vehicle. The vehicle 1 may be a heavy vehicle, such as a bus or a truck, but is not limited thereto. The vehicle 1 comprises a front 2, a back 3 and two opposing longitudinal sides 4 (wherein only one of the longitudinal sides is visible in the figure). The vehicle I may comprise one or more image capturing devices 5 configured to monitor the surroundings of the vehicle. Such image capturing devices may be arranged on any side of the vehicle, including on top of the vehicle as well as arranged on an underside of the vehicle. At least one of the image capturing devices 5 may be configured to monitor and capture the surroundings in a rearward direction of the vehicle, as illustrated by the arrow RW, either along the longitudinal sides of the vehicle or behind the vehicle. Thus, at least one of the image capturing devices 5 may be configured to collect data which may be used for assessment of a traffic situation behind the vehicle 1. The vehicle 1 may further comprise a radar sensor 6, and/or a lidar sensor 7, directed in the rearward direction RW and configured to collect data which may be used for assessment of a traffic situation behind the vehicle. Each of the radar sensor 6 and the lidar sensor 7 may be arranged at the back of the vehicle, on top of the vehicle or on an underside of the vehicle.

The vehicle 1 further comprises a predictive cruise control 200 configured to control the vehicle speed in accordance with a planned vehicle speed profile for an upcoming road section. The vehicle further comprises a control device 100 configured to control the predictive cruise control 200. The control device 100 may be comprised in the predictive cruise control 200 or be separate from the predictive cruise control 200.

FIG. 2 schematically illustrates a plurality of exemplified vehicle speed profiles for an upcoming road section. More specifically, a first simulated vehicle speed profile 11, a second simulated vehicle speed profile 12 and a third simulated vehicle speed profile 13 are shown. The upcoming road section is here represented by the distance D and starts at a position of the vehicle or at a predetermined distance in front of the vehicle. Each of the vehicle speed profiles 11, 12, 13 represents a certain driving strategy for the predictive cruise control for the upcoming road section while seeking to essentially maintain a set speed cc_set selected by e.g. a driver of the vehicle. The figure also illustrates a minimum speed threshold v_min and a maximum speed threshold v_max, which together defines the speed interval within which the vehicle speed may be allowed to varied by the predictive cruise control while seeking to essentially maintain the set speed cc_set.

As evident from the figure, the exemplified first vehicle speed profile 11 and second vehicle speed profile 12 are associated with variations in vehicle speed which fall within the control values v_min and v_max of the predictive cruise control. Thus, the predictive cruise control may select any one of the first and second vehicle speed profiles for the control of vehicle speed for the upcoming road section, and may thus select the one which represents the driving strategy having the lowest energy consumption of the vehicle. However, the exemplified third vehicle speed profile 13 may not be selected by the predictive cruise control in view of resulting in a vehicle speed, at a distance point Dx, which falls below the minimum speed threshold v_min.

However, by means of the herein described method, a currently selected minimum speed threshold of the predictive cruise control may be adjusted to correspond to a determined minimum allowable vehicle speed v_a in case the predetermined condition is fulfilled. If so, the predictive cruise control may also utilize the third vehicle speed profile 13 for the control of vehicle speed for the upcoming road section if it finds that this presents a more energy efficient driving strategy of the vehicle. Thereby, the herein described method enables further energy savings, which in turn improves the operating costs of the vehicle. As already discussed above, the minimum allowable vehicle speed v_a is determined based on an assessment of a traffic situation behind the vehicle and a current set speed cc_set.

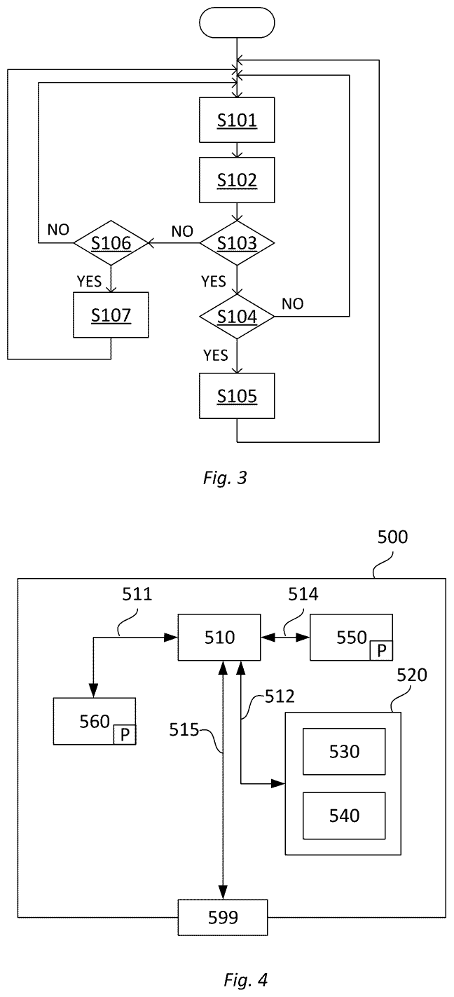

FIG. 3 represents a flowchart schematically illustrating one exemplifying embodiment of the herein described method for controlling a predictive cruise control of a vehicle. The method is performed by a control device configured therefore.

The method comprises a step S101 of assessing the traffic situation behind the vehicle. Step S101 may alternatively be replaced by the control device obtaining such an assessment from a remote source. The method further comprises a step S102 of, based on the assessment of a traffic situation behind the vehicle and a current set speed, determining a minimum allowable vehicle speed. The method thereafter proceeds to a step S103 of determining whether the determined minimum allowable vehicle speed is lower that a currently selected minimum speed threshold of the predictive cruise control.

In case it is determined in step S103 that the determined minimum allowable vehicle speed is lower than the currently selected minimum vehicle speed threshold, the method proceeds to a step S104 of determining whether a predefined condition is fulfilled. In case it is determined that the predetermined condition is fulfilled, the method proceeds to a step S105 of adjusting the currently selected minimum speed threshold to correspond to the determined minimum allowable vehicle speed. After step S105, the method is reverted to start. However, in case it is determined that the predefined condition is not fulfilled, the method is returned to start.

In case it is determined in step S103 that the determined minimum vehicle speed is not lower than the currently selected minimum vehicle speed threshold, the method may proceed to a step S106 of determining whether the determined minimum vehicle speed is higher that the currently selected minimum speed threshold, optionally by at least a predefined difference threshold value. If this is not the case, the method may be reverted to start. However, in case it is found in step S106 that the determined minimum vehicle speed is higher than the currently selected minimum speed threshold, optionally by at least said predefined difference threshold value, the method may proceed to a step S107 of adjusting the currently selected minimum speed threshold to correspond to the determined minimum allowable vehicle speed or to a predefined default minimum speed threshold. The method is thereafter reverted to start.

FIG. 4 schematically illustrates an exemplifying embodiment of a device 500. The control device 100 described above may for example comprise the device 500, consist of the device 500, or be comprised in the device 500.

The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

There is provided a computer program P that comprises instructions for controlling a predictive cruise control of a vehicle. Said predictive cruise control is configured to control vehicle speed in accordance with a planned vehicle speed profile for an upcoming road section, wherein the planned vehicle speed is determined based on a set speed, a minimum speed threshold and characteristics of the upcoming road section. The computer program comprises instructions for, based on an assessment of a traffic situation behind the vehicle and a current set speed, determining a minimum allowable vehicle speed. The computer program further comprises instructions for, in response to a determination that the determined minimum allowable speed is lower than a currently selected minimum speed threshold and a predetermined condition is fulfilled, adjusting the currently selected minimum speed threshold to correspond to the determined minimum allowable vehicle speed.

The program P may be stored in an executable form or in a compressed form in a memory 560 and/or in a read/write memory 550.

The data processing unit 510 may perform one or more functions, i.e. the data processing unit 510 may effect a certain part of the program P stored in the memory 560 or a certain part of the program P stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit 510 via a data bus 511. The read/write memory 550 is adapted to communicate with the data processing unit 510 via a data bus 514. The communication between the constituent components may be implemented by a communication link. A communication link may be a physical connection such as an optoelectronic communication line, or a non-physical connection such as a wireless connection, e.g. a radio link or microwave link.

When data are received on the data port 599, they may be stored temporarily in the second memory element 540. When input data received have been temporarily stored, the data processing unit 510 is prepared to effect code execution as described above.

Parts of the methods herein described may be affected by the device 500 by means of the data processing unit 510 which runs the program stored in the memory 560 or the read/write memory 550. When the device 500 runs the program, methods herein described are executed.

1. A method, performed by a control device, for controlling a predictive cruise control of a vehicle, said predictive cruise control configured to control vehicle speed in accordance with a planned vehicle speed profile for an upcoming road section,
said planned vehicle speed profile being determined based on a set speed (cc_set), a minimum speed threshold (v_min) and characteristics of the upcoming road section, the method comprising the following steps:
based on an assessment of a traffic situation behind the vehicle and a current set speed (cc_set), determining a minimum allowable vehicle speed (v_a), and
in response to a determination that the determined minimum allowable vehicle speed (v_a) is lower than a currently selected minimum speed threshold (v_min) and a predetermined condition is fulfilled, adjusting the currently selected minimum speed threshold (v_min) to correspond to the determined minimum allowable vehicle speed (v_a).

2. The method according to claim 1, further comprising a step of assessing the traffic situation behind the vehicle, said step comprising determining whether there is at least one other road user present behind the vehicle.

3. The method according to claim 2, wherein determining whether there is at least one other road user present behind the vehicle is performed by analysis of at least one of:
data obtained from at least one sensor onboard the vehicle, or
information received via a communication system configured to allow the control device to receive information from a remote source.

4. The method according to claim 3, wherein said sensor is selected from the group consisting of a radar sensor, a lidar sensor, or an image capturing device.

5. The method according to claim 2, wherein the step of assessing the traffic situation behind the vehicle (1) further comprises at least one of:
identifying the type of said at least one other road user present behind the vehicle, or
estimating the travelling speed of said at least one other road user present behind the vehicle.

6. The method according to claim 1, wherein the predetermined condition includes that adjustment of the minimum speed threshold is permitted for a currently operative performance mode of the vehicle.

7. The method according to claim 1, wherein the method further comprises a step of:
in response to a determination that the determined minimum allowable speed is lower than the currently selected minimum speed threshold, proposing an adjustment of the minimum speed threshold to a driver of the vehicle and enabling the driver, by use of a user interface, to request said adjustment; and
wherein the predetermined condition includes that a driver-initiated request for adjustment of the minimum speed threshold has been generated.

8. The method according to claim 1, wherein the predetermined condition includes that the characteristics of the upcoming road section are determined to allow for safe overtaking of the vehicle by other road users.

9. The method according to claim 8, further comprising determining whether the characteristics of the upcoming road section allow for safe overtaking of the vehicle by other road users based on the number of lanes with the same direction of travel as the direction of travel of the vehicle.

10. The method according claim 1, wherein the step of determining a minimum allowable vehicle speed (v_a) comprises selecting the minimum allowable speed (v_a) from a look-up table comprising predefined values for minimum allowable speeds for different set speeds and assessments of traffic situation behind the vehicle.

11. The method according to claim 2, wherein the step of determining a minimum allowable vehicle speed (v_a) comprises estimating a possible lowest vehicle speed of the vehicle enabling said at least one other road user to reach a minimum allowable trailing distance to the vehicle.

12. The method according to claim 1, further comprising a step of:
in response to a determination that the determined minimum allowable speed is higher than a currently selected minimum speed threshold, optionally by at least a predefined difference threshold value, adjusting the currently selected minimum speed threshold (v_min) to correspond to the determined minimum allowable vehicle speed (v_a) or a predefined default minimum speed threshold.

13. (canceled)

14. A computer-readable medium comprising instructions which, when executed by a control device, cause the control device to carry out the method according to claim 1.

15. A control device configured to control a predictive cruise control of a vehicle, said predictive cruise control configured to control vehicle speed in accordance with a planned vehicle speed profile for an upcoming road section,
said planned vehicle speed profile being determined based on a set speed (cc_set), a minimum speed threshold (v_min) and characteristics of the upcoming road section, wherein the control device is configured to:
based on an assessment of a traffic situation behind the vehicle and a current set speed (cc_set), determine a minimum allowable vehicle speed (v_a), and
when the determined minimum allowable speed (v_a) is lower than a currently selected minimum speed threshold (v_min) and a predetermined condition is fulfilled, adjust the currently selected minimum speed threshold (v_min) to correspond to the determined minimum allowable vehicle speed (v_a).

16. A predictive cruise control system configured to control vehicle speed of a vehicle, the predictive cruise control system comprising the control device according to claim 15.

17. A vehicle comprising the control device according to claim 15.
